(19) United States
(12) Patent Application Publication
(10) Pub. No.: US 2006/0107761 A1
(43) Pub. Date: May 25, 2006

(54) Multi-axis load cell body

(76) Inventors: Richard A. Meyer, Chaska, MN (US); Douglas J. Olson, Plymouth, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 11/280,723

(22) Filed: Nov. 16, 2005

Related U.S. Application Data
(60) Provisional application No. 60/628,321, filed on Nov. 16, 2004.
(60) Provisional application No. 60/634,649, filed on Dec. 9, 2004.

(51) Int. Cl. G01L 1/22

(52) U.S. Cl. 73/862.044

(57) ABSTRACT

A load cell body for transmitting forces and moments in a plurality of directions includes an integral assembly having a first ring member and a second ring member. Each ring member has a central aperture centered on a reference axis. In one embodiment, three or more sensor assemblies extend from the first ring member to the second ring member parallel to the reference axis. The sensor assemblies include spaced-apart apertures forming flexure members.

### CROSS-REFERENCE TO RELATED APPLICATION

The present application is based on and claims the benefit of U.S. provisional patent application Ser. No. 60/628,321, filed Nov. 16, 2004 and U.S. provisional patent application Ser. No. 60/634,649, filed Dec. 9, 2004 the contents of which are both hereby incorporated by reference in their entirety.

### BACKGROUND OF THE INVENTION

The discussion below is merely provided for general background information and is not intended to be used as an aid in determining the scope of the claimed subject matter.

The present disclosure relates to a load cell that transmits and measures linear forces along and moments about three orthogonal axes. More particularly, a compact load cell body that can be used as a wheel force transducer is disclosed.

Wheel force transducer or load cells for measuring forces along or moments about three orthogonal axes are known. The wheel force transducer typically is mounted between and to a vehicle spindle and a portion of a vehicle rim. The transducer measures forces and moments reacted through a wheel assembly at the spindle as the vehicle is operated.

Wheel force transducers that have enjoyed substantial success and critical acclaim are sold under the trade designation Swift® and Swift® 50 transducers by MTS Systems Corporation of Eden Prairie, Minn. and are described in detail in U.S. Pat. Nos. 5,969,268, 6,038,933, and 6,769,312. Generally, these transducers include a load cell body having a plurality of tubular members. A plurality of sensing circuits are mounted to the plurality of tubular members. The load cell body is attached to a vehicle wheel. An encoder measures the angular position of the load cell body allowing the forces transmitted through the radial tubular members to be resolved with respect to an orthogonal stationary coordinate system.

### SUMMARY OF THE INVENTION

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter. In addition, the description herein provided and the claimed subject matter should not be interpreted as being directed to addressing any of the short-comings discussed in the Background.

One embodiment described herein is a load cell body for transmitting forces and moments in a plurality of directions. The load cell body is an integral assembly having a first ring member and a second ring member. Each ring member has a central aperture centered on a reference axis. Three or more sensor assemblies extend from the first ring member to the second ring member parallel to the reference axis. In one embodiment, the sensor assemblies include spaced-apart to form three pairs of flexure members.

The isolation openings provide for displacement of the sensing apertures and also for isolation between the sensor assemblies within the load cell to reduce or prevent cross-talk between the sensor assemblies. A large mass area between the apertures and openings provides for increased rigidity and reduced hysteresis, and thus better performance in the measurement of forces and moments. The sensor assemblies are compact, strong, and provide for high stress and/or strain concentrations at the locations of the sensing apertures. In addition, with sensors applied to the sensor assemblies, the load cell can readily be incorporated into existing measurement and transformation circuits currently in use with existing load cells.

Yet another aspect herein described includes a method of making a load cell body. The method includes fabricating from a single block of material an integral assembly having a first annular ring, a second annular ring and a plurality of sensor assemblies spanning therebetween. Each ring member includes a central aperture centered on a reference axis. The method further includes forming a plurality of bores, openings or slots to define each of the sensor assemblies, wherein each bore, opening or slot is in a direction generally perpendicular to the reference axis. Thus the load cell body of the present disclosure is relatively easy to manufacture.

### BRIEF DESCRIPTION OF THE DRAWINGS

FIG. 1A is a perspective view of a load cell in accordance with the present disclosure.

FIG. 1B is a front elevational view of the load cell illustrated in FIG. 1A.

FIG. 1C is a side elevational view of the load cell illustrated in FIG. 1A.

FIG. 2 is a schematic diagram illustrating placement of sensors on the load cell.

FIG. 3A is a schematic drawing of electrical circuits used to measure forces and moments about an orthogonal coordinate system.

FIG. 3B is a schematic drawing of an alternative electrical circuit used to measure forces and moments about the orthogonal coordinate system.

FIG. 4A is a side sectional view of the load cell mounted to a tire rim.

FIG. 4B is a side sectional view of the load cell mounted to another example of a tire rim.

FIG. 4C is a side sectional view of the load cell mounted to a dual-wheel assembly.

FIG. 4D is a side sectional view of the load cell mounted another example of a dual-wheel assembly.

FIG. 5 is a front elevational view of the transducer.

FIG. 6 is a general block diagram of a controller.

FIG. 7 is a block diagram of a scaling and geometric transformation circuit.

FIG. 8 is a circuit diagram of a portion of a cross coupling matrix circuit.

FIG. 9 is a block diagram of a coordinate transformation circuit.

FIG. 10 is a side elevational view of another embodiment of a load cell constructed in accordance with the present disclosure.

### DETAILED DESCRIPTION OF THE ILLUSTRATIVE EMBODIMENTS

U.S. Pat. No. 6,038,933 titled “Multi-Axis Load Cell” and U.S. Pat. No. 6,769,312 titled “Multi-Axis Load Cell Body” are incorporated by reference into this disclosure.

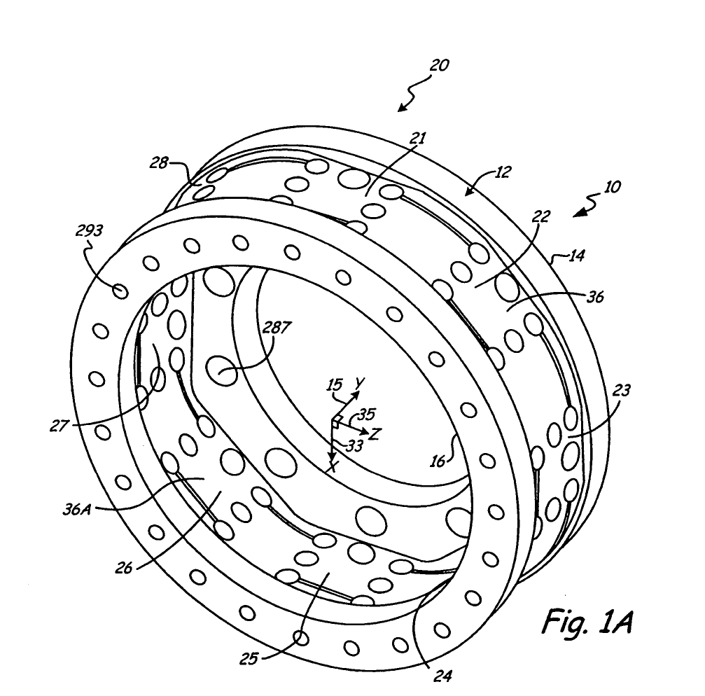

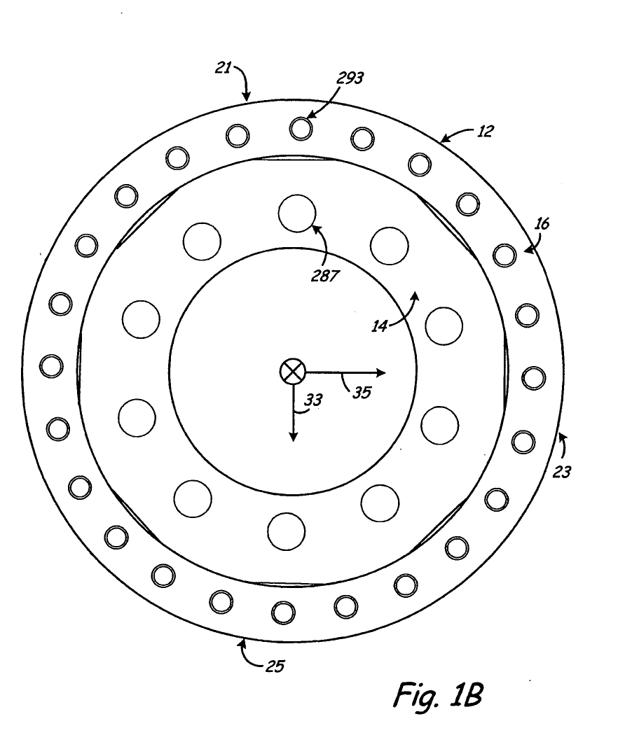

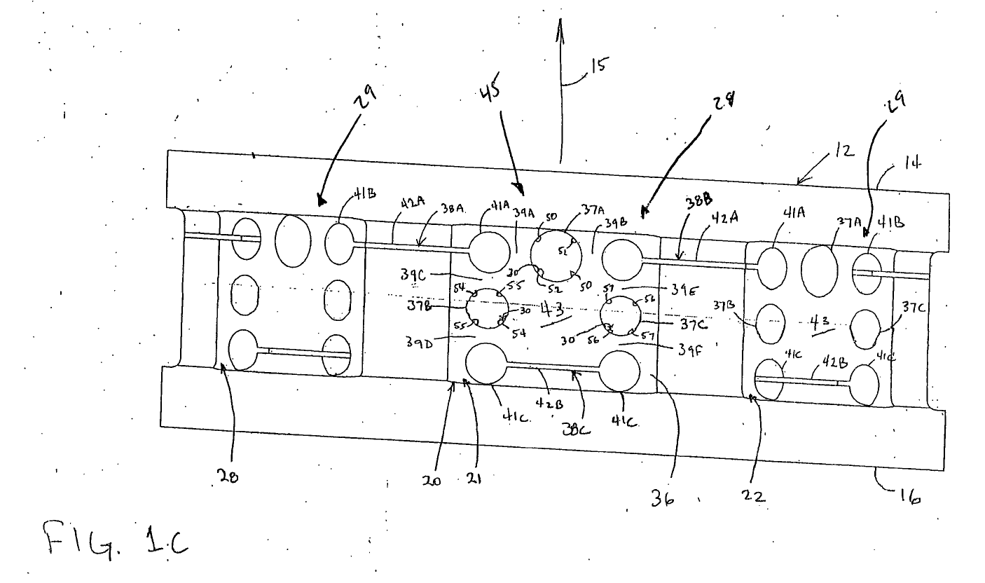

FIGS. 1A and 1B illustrate an embodiment of a load cell 10 of the present disclosure. The load cell 10 preferably includes an integral body 12 fabricated from a single block of material. The body 12 includes a first rigid annular ring 14 and a second annular ring 16 that is parallel and aligned with the first annular ring 14 so as to be centered about a common axis 15. A plurality of sensor assemblies 20 join the first annular ring 14 to the second annular ring 16. In the embodiment illustrated, the plurality of sensor assemblies 20 comprise eight assemblies 21, 22, 23, 24, 25, 26, 27 and 28. Each of the assemblies 21-28 extends from the first annular ring 14 to the second annular ring 16. Although illustrated wherein the plurality of sensor assemblies 20 equals eight, it should be understood that any number of sensor assemblies three or more can be used between the first annular ring 14 to the second annular ring 16. In the embodiment illustrated, the plurality of sensor assemblies 20 are spaced at substantially equal angular intervals about the axis 15.

A plurality of sensors 30 are mounted on the plurality sensor assemblies 20 to sense stresses or strain. In the embodiment illustrated, strain gauges are incorporated in a plurality of Wheatstone bridges. Eight Wheatstone bridges are shown in the present examples. The Wheatstone bridges are combined into sensor signals that are provided as an output from the load cell 10. In the example shown, the eight Wheatstone bridges are combined into eight sensor signals. For purposes of explanation, an orthogonal coordinate system can be defined wherein an X-axis is indicated at 33, a Z-axis is indicated at 35, and a Y-axis corresponds to the central axis 15. The sensor signals from the load cell 10, as explained below, are used to calculate forces along and moments about the X-axis 33, the Y-axis 15 and the Z-axis 35.

Each of the sensor assemblies includes the same general construction, which is illustrated with reference to sensor assemblies 21, 22 and 28 shown in FIG. 1C. In the embodiment illustrated, sensor assembly 21 includes a generally planar outside surface 36 and a planar inside surface (36A in FIG. 1A) with a plurality of spaced-apart bores or apertures 29. In the embodiment illustrated, the spaced-apart apertures 29 include three spaced-apart radially-extending sensing apertures 37A, 37B, 37C and three isolation apertures or openings (herein referred to as “isolation openings”) 38A, 38B, 38C. In the example shown, the sensing apertures are spaced apart from the isolation openings and the annular rings 14, 16.

Generally, the spaced-apart apertures 29 form flexure members 45. In the embodiment illustrated, the sensing apertures and isolation openings form three pairs of flexure members. The first sensing aperture 37A is located between isolation openings 38A, 38B and forms a first pair of flexure members 39A 39B generally parallel to each other, substantially identical and extending in a direction parallel to the Y axis 15. The flexure members 39A, 39B are joined to the annular ring 14 on a first end thereof. The second sensing aperture 37B is located between isolation openings 38A, 38C and forms a second pair of flexure members 39C, 39D generally parallel to each other, substantially identical and perpendicular to the Y axis 15. Similarly, the third sensing aperture 37C is located between isolation openings 38B, 38C and forms a third pair of flexure members 39E, 39F generally parallel to each other, substantially identical and perpendicular to the Y axis 15. A first end of each second flexure member 39C, 39D, 39E, and 39F is joined to the first flexure members 39A, 39B, while the second end is joined to the annular ring 16. The second flexure members 39C, 39D extend in a direction opposite to that of second flexure members 39E, 39F. As illustrated, in one embodiment, seven apertures are used to define the flexure members, wherein three are used to form each pair of flexure members.

Two isolation openings 38A, 38B extend into the respective immediate adjacent sensor assemblies 28, 22. Accordingly, isolation opening 38A extends into sensor assembly 28, and isolation opening 38B extends into sensor assembly 22. The isolation openings 38A, 38B, 38C are not restricted to a particular shape. In the example shown, each isolation opening comprises a slit joined to the isolation apertures on each end of two adjacent sensor assemblies. Isolation opening 38A common with sensor assembly 28 includes isolation aperture 41A and slit 42A coupled to isolation aperture 41B on sensor assembly 28. Isolation opening 38B common with sensor assembly 22 includes isolation apertures 41B and slit 42A coupled to isolation aperture 41A on sensor assembly 22.

Isolation opening 38C located generally within sensor assembly 21 includes isolation apertures 41C with a slit 42B joining the isolation apertures 41C. The isolation openings and sensing apertures are formed around a mass area 43 located generally in the central portion of the sensor assemblies 20. In other words, each sensor assembly includes one of the apertures 41C forming one of the second flexure members 39D extending in the first direction joined to one of the apertures 41C forming one of the second flexure members 39F extending in the second direction with an isolation opening 42B.

The sensor assemblies 20 are adapted to receive sensing gauges 30 within the sensing apertures 37A, 37B, 37C. The sensing gauges 30 detect stresses and/or strain on the flexure members. Each sensor assembly 20 is generally sensitive in 2 orthogonal axes. Each of the pairs of flexure members (39A, 39B), (39C, 39D), (39E, 39F) are generally sensitive along a single coordinate axis as a result of forces and moments on and about the load cell 10. Thus, each pair of flexure members is compliant/sensitive in a single direction and generally rigid/insensitive in the other two directions. For example, flexure members 39C, 39D, 39E, 39F are compliant in the Y direction and generally rigid in the X and Z directions. Flexure members 39A, 39B are compliant in the Z direction and generally rigid in the X and Y directions. Depending on the orientation of sensing aperture 37A, flexure members 39A, 39B can be compliant in the X direction and generally rigid in the Y and Z directions.

Although sensors are mounted conventionally to provide an output signal indicative of bending stresses in the flexure members 39A-39F such as compression and tension, other forms of sensors such as those that provide an indication of shear stresses can also be used as appreciated by those skilled in the art. Likewise, many other forms of sensing devices such as optically based sensors or capacitively based sensors can also be used.

In one embodiment, the load cell 10 is constructed from a single block of material as an integral assembly having the first annular ring 14, the second annular ring 16, and a generally cylindrical member extending therebetween. In one embodiment, the member is fabricated to form at least three planar surfaces on the outside wall of the member spaced apart at substantially equal angular intervals about the axis 15. Each of the planar surfaces will become a sensor assembly 20. The planar surfaces are then bored to form the sensing apertures and the isolation apertures per sensor assembly 20. This process is repeated around the member to form all of the apertures in each sensor assembly 20. The inside wall of the member is also planed to form the sensor assemblies 20. A cutting blade is inserted into one of the isolation apertures and the member is cut to the form the isolation slit to the corresponding opposite isolation aperture. This process is repeated for each pair of isolation apertures. Mounting apertures are also bored parallel to the axis 15 on the first and second ring members 14, 16, to form the load cell body 12. The load cell body 12 can be manufactured from aluminum, titanium, 4340 steel, 17-4 pH stainless steel or other high-strength materials.

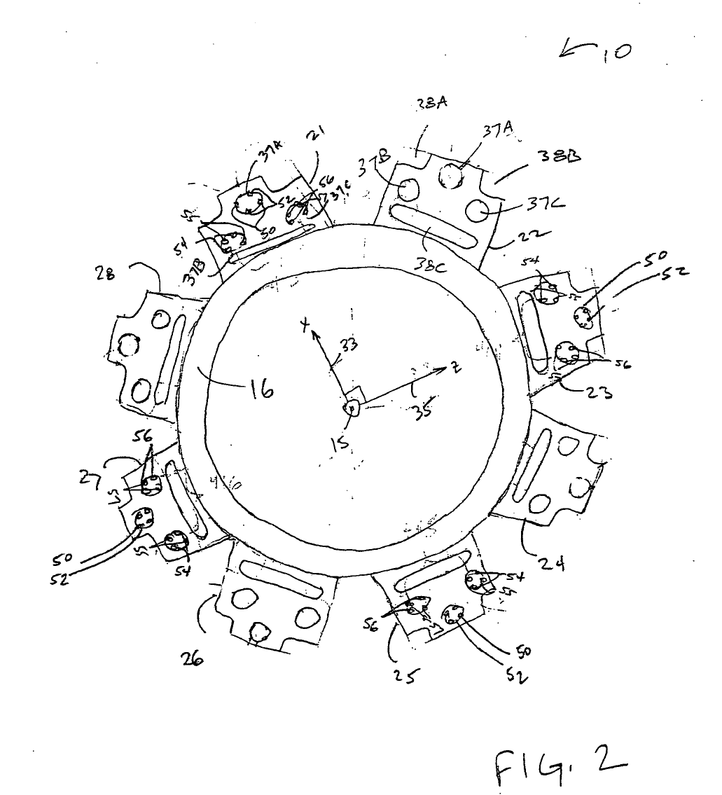

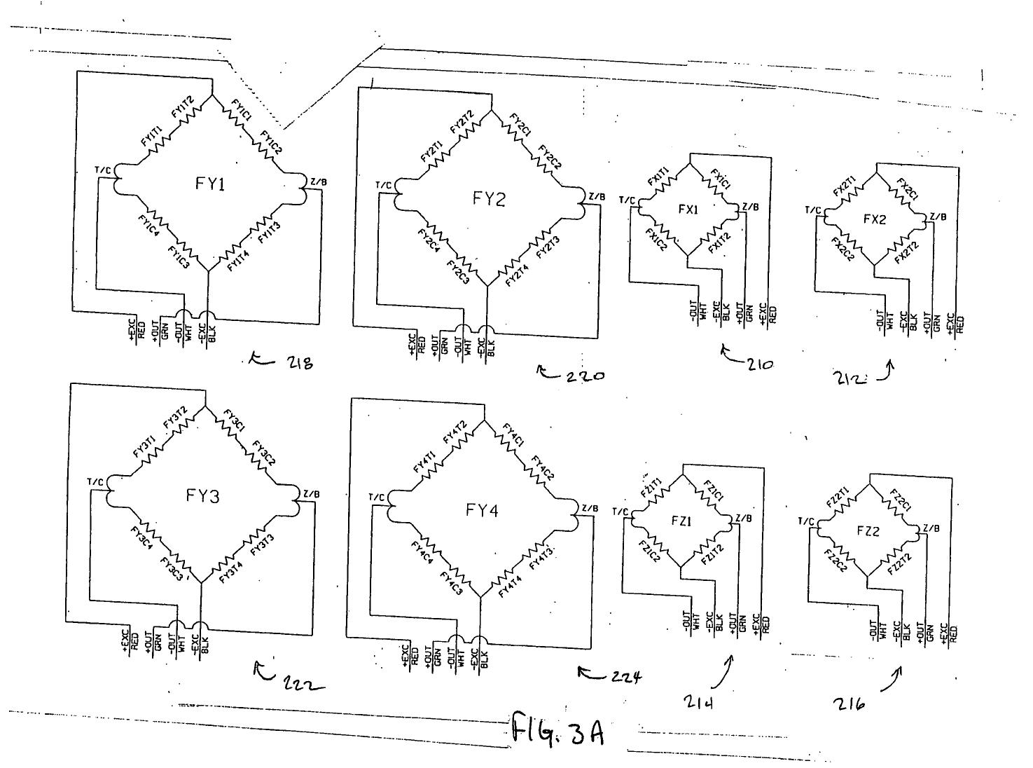

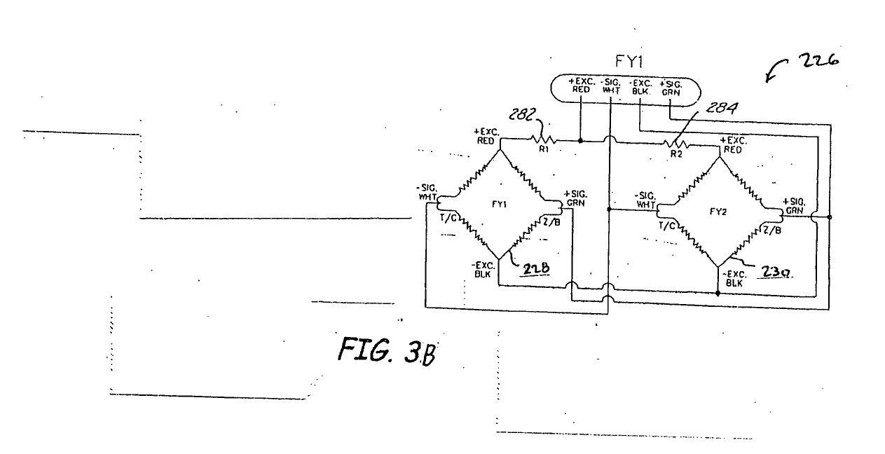

FIGS. 2 and 3A illustrate location and connection of the gauges into eight Wheatstone bridges. FIG. 2 is the load cell shown indicating ring 16 with sensor assemblies 20 “detach and bent” away from ring 14 so as that all sensor assemblies 21, 22, 23, 24, 25, 26, 27, 28 are visible in a single view. Generally, every other sensor assembly, i.e., sensor assemblies 21, 23, 25, 27, includes a first pair of sensors 50 provided within sensing aperture 37A of each sensor assembly 21, 23, 25, 27. A second pair of sensors 52 is also provided within sensing aperture 37A approximately 90 degrees from the first pair of sensors 50. The first and second pairs of sensors 50, 52 on every other sensor assembly 21, 23, 25, 27 are connected in a conventional Wheatstone bridge to form a first sensing circuit on each sensor assembly 21, 23, 25, 27 for flexure members 39A, 39B. The first Wheatstone bridge senses forces along one of the axes 33 or 35. Specifically, in the embodiment illustrated, forces along the X-axis 33 are calculated from output signals from the first Wheatstone bridges provided on each of the sensor assemblies 23 and 27. Similarly, output signals from the first Wheatstone bridge on each of the sensor assemblies 21 and 25 are used to calculate forces along the Z-axis 35. As discussed above in the illustrated embodiment, each of the first Wheatstone bridge circuits is a bending sensing circuits.

A second sensing circuit on every other of the sensor assemblies 21-28, specifically sensor assemblies 21, 23, 25, and 27 in the example, sense axial tension/compression along the Y-axis 15. Each of the second Wheatstone bridge circuit includes third and fourth pairs of sensors 54, 55 mounted approximately 90 degrees from each other within sensing aperture 37B, and fifth and sixth pairs of sensors 56, 57 are mounted approximately 90 degrees from each other within sensing aperture 37C on sensor assemblies 21, 23, 25, and 27.

FIG. 3A is a schematic diagram illustrating connection of the Wheatstone bridges on sensor assemblies 21, 23, 25, 27 in order to realize eight output signals from load cell. The eight outputs are indicative of eight measurements of separate forces on the load cell 10 including two forces along the X-axis 33, Fₓ₁ and Fₓ₂; two forces along the Z-axis 35, F_{z1} and F_{z2}; and four forces along the Y-axis 15, F_{y1}, F_{y2}, F_{y3}, and F_{y4}. These eight measurements are then later resolved into the six forces and moments on the load cell.

A first Wheatstone bridge circuit 210 is created from sensor pairs 50, 52 for flexure members 39A and 39B of sensor assembly 23, while a first Wheatstone bridge circuit 212 is created from sensor pairs 50, 52 for flexure members 39A and 39B of sensor assembly 27. In the illustrated example where the sensor assemblies 23, 27 are oriented with respect to the X-axis 33 as shown, the Wheatstone bridge circuits 210, 212 can sense forces along the X-axis 33.

A first Wheatstone bridge circuit 214 is created from sensor pairs 50, 52 for flexure members 39A and 39B of sensor assembly 21, while a first Wheatstone bridge circuit 216 is created from sensor pairs 50, 52 for flexure members 39A and 39B of sensor assembly 25. In the illustrated example where the sensor assemblies 21, 25 are oriented with respect to the Z-axis 35 as shown, the Wheatstone bridge circuits 214, 216 can sense forces along the Z-axis 35.

Sensor pairs 54, 55 within sensing apertures 37B and sensor pairs 56, 57 within sensing apertures 37C of each of sensor assemblies 21, 23, 25, 27 are also combined in Wheatstone bridges 218, 220, 222, 224. In the illustrated example, the Wheatstone bridges including sensor pairs 54, 55, 56, 57 of the sensor assemblies 21, 23, 25, 27 are adapted to sense forces along the Y-axis 15, as illustrated.

Wheatstone bridge 218 corresponds with sensor assembly 23, where a sensor in sensor pair 54 or 55 of one aperture, such as 37B, is combined in series with a similarly oriented sensor of the same sensor pair 56 or 57 in the other one of the aperture, such as 37C, in the same sensor assembly. This connection is similar for all four of the sensor pairs 54, 55, 56, 57 in each of the sensor assemblies 21, 23, 25, 27. Wheatstone bridge circuit 220 corresponds with sensor assembly 21, Wheatstone bridge circuit 222 corresponds with sensor assembly 27, and Wheatstone bridge circuit 224 corresponds with sensor assembly 25.

According to the above configuration, sensor assembly 21 corresponds with Wheatstone bridges 214 and 220 measuring F_{z1} and F_{y2}, respectively, when the load cell is oriented with respect to the axes as shown. Sensor assembly 23 corresponds with Wheatstone bridges 210 and 218 measuring Fₓ₁ and F_{y1}, respectively. Sensor assembly 25 corresponds with Wheatstone bridges 216 and 224 measuring F_{z2} and F_{y4}, respectively. Finally, sensor assembly 27 corresponds with Wheatstone bridges 212 and 222 measuring Fₓ₂ and F_{y3}, respectively.

FIG. 3B is a schematic diagram of a Wheatstone bridge circuit 226 illustrating an alternate configuration possible for the Wheatstone bridge circuits 218, 220, 222, or 224 of FIG. 3A. Wheatstone bridge circuit 226 includes two Wheatstone bridge circuits 228 and 230 connected in parallel. The sensor pairs 54 and 56 are combined in Wheatstone bridge 228, and the sensor pairs 55 and 57 are combined in Wheatstone bridge circuit 230. The sensor pairs 54, 55, 56, 57 are combined in parallel in circuit 226 rather than in series as in circuits 218, 220, 222 and 224. Wheatstone bridge circuit 226 also includes resistors 282 and 284 that are chosen to match sensitivity of each Wheatstone bridge circuit 228, 230 in order to combine their outputs and to effectively form one output signal.

In the first example, every other sensor assembly includes sensors to sense stresses along the orthogonal axes. This is done in the example so that the sensor can be connected in a manner that will work with existing electronics used with other known load cells. In an alternative embodiment, all eight sensor assemblies could be configured to measure loads with respect to the axes.

As appreciated by those skilled in the art, it is not necessary that the Wheatstone bridge circuits be combined as illustrated in FIG. 3A or 3B in order to practice the present invention. In other words, the output signal provided by each Wheatstone bridge can be obtained wherein suitable hardware or software is used to resolve each of the corresponding output signals with respect to the coordinate system of orthogonal axes 33, 35 and 15. However, connection of the Wheatstone bridges as described above can realize manufacturing cost savings by reducing the number of output signals provided from the load cell 10.

In the embodiment illustrated, the load cell 10 provides eight signals as described above. The eight signals are then transformed to provide forces and moments about the axis of the coordinate system 31. Specifically, force along the X-axis 33 is measured as principal stresses or strains due to bending stresses created in sensor assemblies 23 and 27. This can represented as:
Fₓ=Fₓ₁+Fₓ₂;
where the outputs Fₓ₁ and Fₓ₂ are obtained as indicated in FIG. 3A.

Similarly, force along the Z-axis 35 is measured as principal stresses or strains due to bending stresses created in the sensor assemblies 21 and 25. This can be represented as:
F_{z}=F_{z1}+F_{z2};
where the outputs F_{z1} and F_{z2} are obtained as indicated in FIG. 3A.

Force along the Y-axis 15 is measured as axial tension/compression created in sensor assemblies 23, 21, 27 and 25. This can be represented as:
F_{y}=F_{y1}+F_{y2}+F_{y3}+F_{y4}
where the outputs F_{y1}, F_{y2}, F_{y3} and F_{y4} are obtained as indicated in FIG. 3A or 3B.

An overturning moment about the X-axis is measured as axial tension/compression forces created in sensor assemblies 23 and 27 from the opposed forces applied thereto. This can be represented as:
Mₓ=F_{y1}−F_{y3}.
Note, that the outputs indicative of F_{y2} and F_{y4} are effectively zero since each of these outputs are formed from sensor assemblies on each side of the X-axis 33.

Likewise, an overturning moment about the Z-axis 35 is measured as axial tension/compression created in sensor assemblies 21 and 25 from the opposed forces applied thereto. This can be represented by:
M_{z}=F_{y4}−F_{y2}.
Note that for a moment about the Z-axis 35, the outputs F_{y1} and F_{y3} are zero.

An overturning moment about the Y-axis 15 is measured as principal strains due to axial tension/compression stresses created in sensor assemblies 23, 27, 21 and 25. This can be represented as:
M_{y}=(Fₓ₁−Fₓ₂)+(F_{z1}−F_{z2})

It should be understood that the number of sensors 30 and the number of sensing circuits can be reduced if measured forces and moments of less than six degrees of freedom is desired.

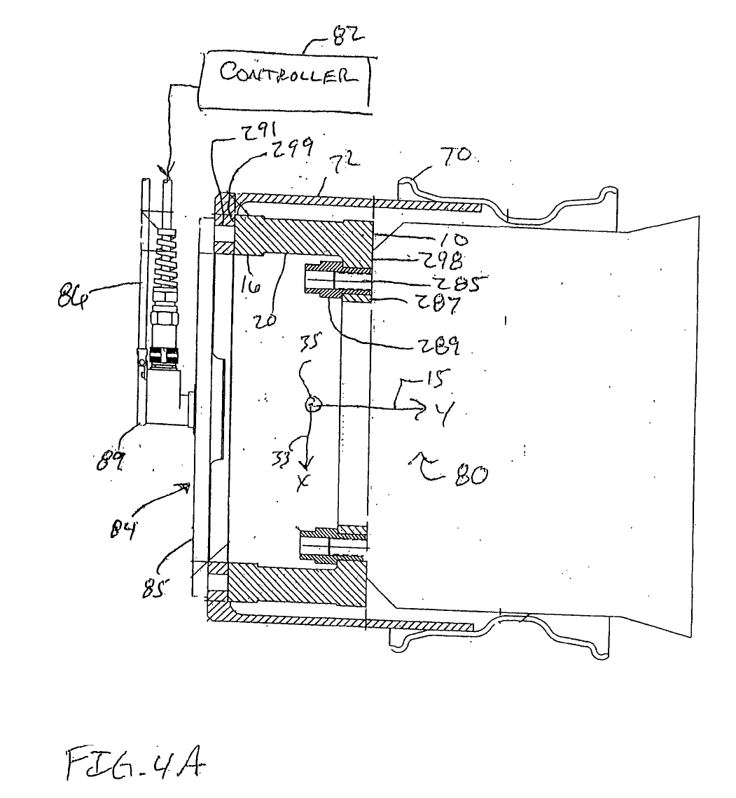

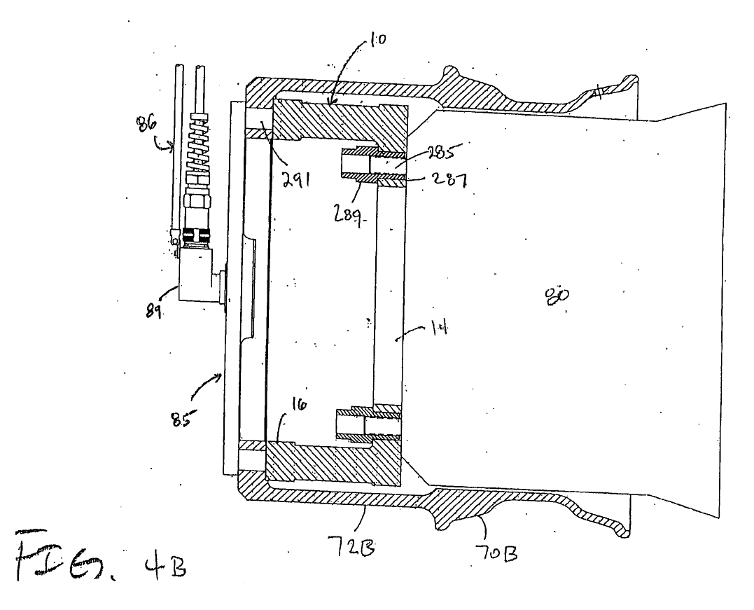

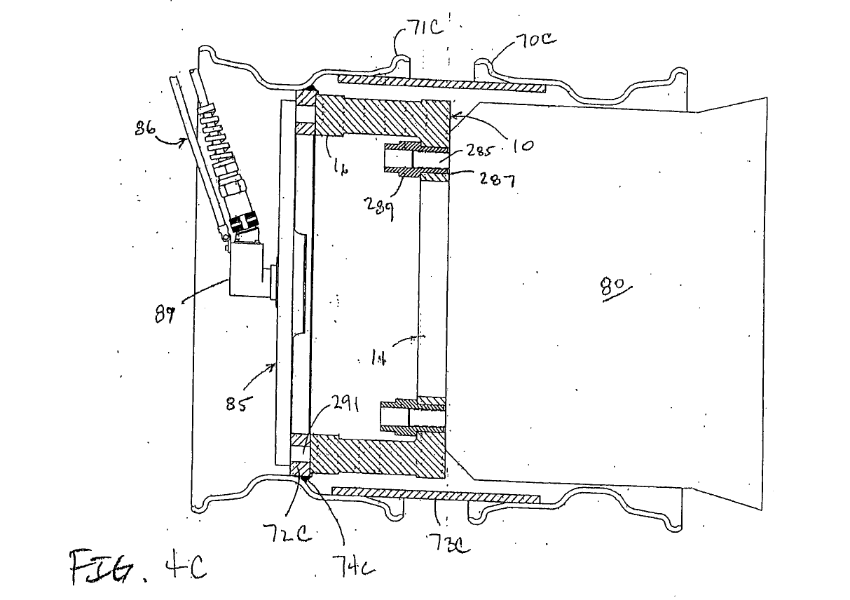

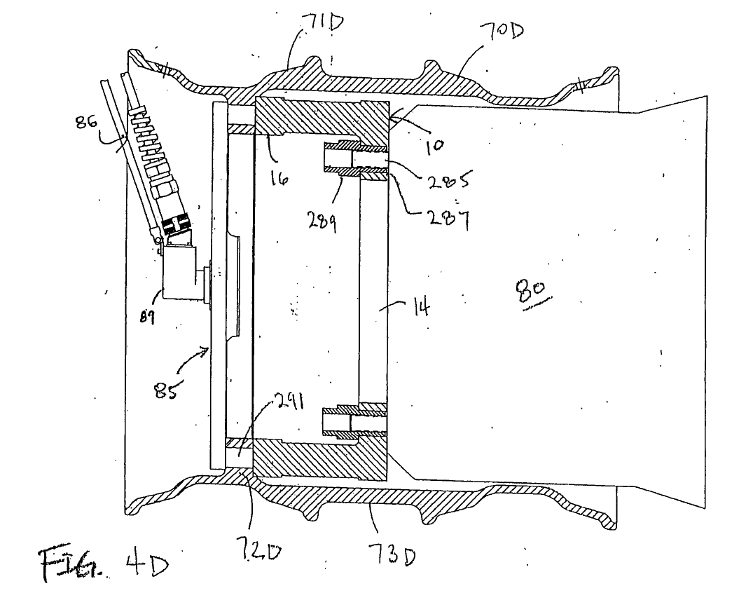

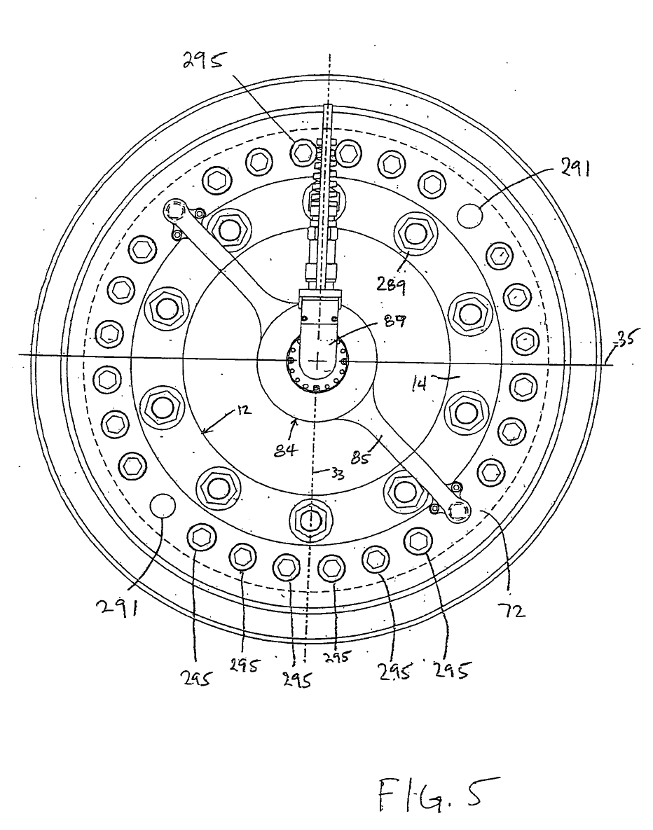

The load cell 10 is particularly well-suited for measuring the force and moment components of a rolling wheel. Referring to FIGS. 4A and 5, the load cell 10 is illustrated as being connected in the load path from a vehicle spindle 80 to a wheel rim 70. In effect, the load cell 10 replaces a center portion of the rim 70 connecting the spindle 80 to the tire interface.

The first annular ring member 14 is secured to the vehicle spindle 80. The vehicle spindle 80 includes a set of mounting bolts 285 that are generally adapted to receive a typical rim or wheel. The first annular member includes a set of mounting apertures 287 extending parallel to the axis 15 that are adapted to mate with the mounting bolts 285. The first annular member 14 is connected to the spindle 80 with fasteners 289 that screw onto the bolts 285. In the example shown, the fasteners 289 include internal screw threads that mate with the bolts 285, and a portion of the fasteners extend into the mounting apertures 287.

The second annular ring member 16 is secured to the vehicle rim 70 with an extending rim flange 72 joined to the rim 70. The load cell 10 fits within the rim flange 72. The rim flange 72 includes a set of mounting apertures 291 adapted to align with mounting apertures 293 on the second annular ring 16. The rim flange 72 is adapted to be attached to the second annular ring 16 with fasteners, such as bolts 295, that extend through the mounting apertures 291 and into aligned threaded mounting apertures 293 of the second annular ring 16 to hold the rim flange insert 72 in place. In one example, the rim flange insert 72 is connected to the second annular ring 16 with 24 bolts 295 in four groups of six bolts.

The load cell 10 can also include raised portions 298 extending slightly above the surface of the first annular ring 14 to concentrate stresses proximate to each mounting aperture 287. Similar raised portions 299 can be provided on the second annular ring 16 proximate to mounting apertures 293 for mounting the load cell 10 to rim flange 72.

A controller 82 provides power to and receives outputs from the sensors 30 through a slip ring assembly 84 if the tire rim 70 rotates or partially rotates. The controller 82 calculates, records and/or displays the force and moment components measured by the load cell 10.

The slip ring assembly 84 includes a slip ring bracket 85 that attaches to mounting apertures 291 of the rim flange insert 72. The slip ring assembly 84 also includes an anti-rotate assembly 86 and an encoder 89. The anti-rotate assembly 86 prevents the encoder 89 from rotating about the axis 15. Sensors 30 are connected to conductors that are carried in passageways in the slip ring bracket 85 to the encoder 89. The encoder 89 provides an angular output signal to the controller 82 indicative of the angular position of the load cell 10.

FIG. 4B shows an alternative design for attaching the load cell 10 to the wheel. In this design, the first annular ring 14 is attached to the spindle 80 in the same manner as shown above. Specifically, the load cell 10 includes apertures 287 that are sized and positioned for the mounting bolts 285 of the spindle 80. Fasteners 289 are screwed onto the bolts 285 to secure the ring 14 to the spindle. A rim flange 72B is integrally formed with rim 70B from a single unitary body, and the rim 70B is reinforced with a thicker load cell-side portion to account for added stress on the rim 70B. The rim flange 72B includes a set of mounting apertures 291 also aligned with the apertures 293 on the second annular ring 16. Bolts are used to attach the rim flange 72B to the second annular ring 16 as described above.

FIG. 4C shows the load cell 10 attached to a dual wheel assembly. The dual-wheel configuration includes a pair of tandem rims 70C, 71C connected together by cylinder member 73C. Again in this design, the first annular ring 14 is attached to the spindle 80 in the same manner as shown above. The load cell 10 includes apertures 287 that are sized and positioned for the mounting bolts 285 of the spindle 80. Fasteners 289 are screwed onto the bolts 285 to secure the ring 14 to the spindle. A rim flange member 72C is attached to rim 71C at weld 74C. The rim flange member 72C includes a set of mounting apertures 291 also aligned with the apertures 293 on the second annular ring 16. Bolts are used to attach the rim flange member 72C to the second annular ring 16 as described above.

FIG. 4D shows the load cell 10 attached to another example of a dual-wheel assembly. In this design, the tandem rims 70D, 71D are integrally formed together at member 73D and also integrally formed with rim flange member 72D all from a single unitary body. As with the afore-mentioned embodiments, the rim flange member 72D includes a set of mounting apertures 291 also aligned with the apertures 293 on the second annular ring 16. Bolts are used to attach the rim flange member 72D to the second annular ring 16. The first annular ring 14 is also attached to the spindle 80 in the same manner as shown above. The load cell 10 includes apertures 287 that are fit over the mounting bolts 285 of the spindle 80. Fasteners 289 are screwed onto the bolts 285 to secure the ring 14 to the spindle.

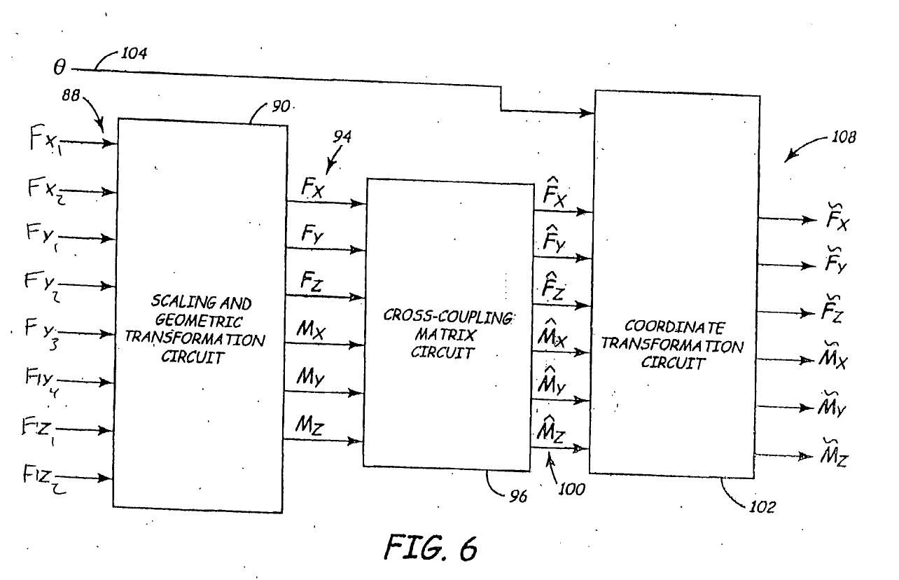

FIG. 6 illustrates generally operation performed by the controller 82 to transform the output signals 88 received from the individual sensing circuits on the sensor assemblies 21-28 to obtain output signals 108 indicative of force and moment components with respect to six degrees of freedom in a static orthogonal coordinate system. As illustrated, output signals 88 from the sensing circuits are received by a scaling and geometric transformation circuit 90. The scaling and geometric transformation circuit 90 adjusts the output signals 88 to compensate for any imbalance between the sensing circuits. Circuit 90 also combines the output signals 88 according to the equations given above to provide output signals 94 indicative of force and moment components for the orthogonal coordinate system.

Referring back to FIG. 6, a cross-coupling matrix circuit 96 receives the output signals 94 and adjusts the output signals so as to compensate for any cross-coupling effects. A coordinate transformation circuit 102 receives output signals 100 from the cross-coupling matrix circuit 96 and an angular input 104 from an encoder or the like. The coordinate transformation circuit 102 adjusts the output signals 100 and provides output signals 108 that are a function of a position of the load cell 10 so as to provide force and moment components with respect to a static orthogonal coordinate system.

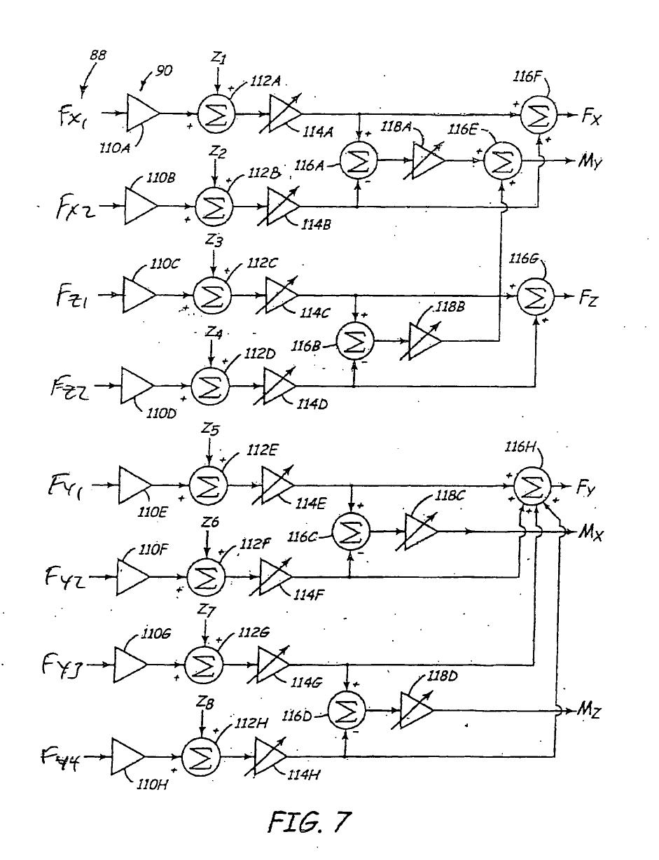

FIG. 7 illustrates the scaling and geometric transformation circuit 90 in detail. High impedance buffer amplifiers 110A to 110H receive the output signals 88 from the slip ring assembly 84. In turn, adders 112A to 112H provide a zero adjustment while, preferably, adjustable amplifiers 114A to 114H individually adjust the output signals 88 so that any imbalance associated with physical differences such as variances in the wall thickness of the location of the sensors 30 on the sensor assemblies 21-28 or variances in the placement of the sensors 30 from assembly to assembly can be easily compensated. Adders 116A to 116H combine the output signals from the amplifiers 114A to 114H in accordance with the equations above. Adjustable amplifiers 118A to 118D are provided to ensure that output signals from adders 116A to 116D have the proper amplitude.

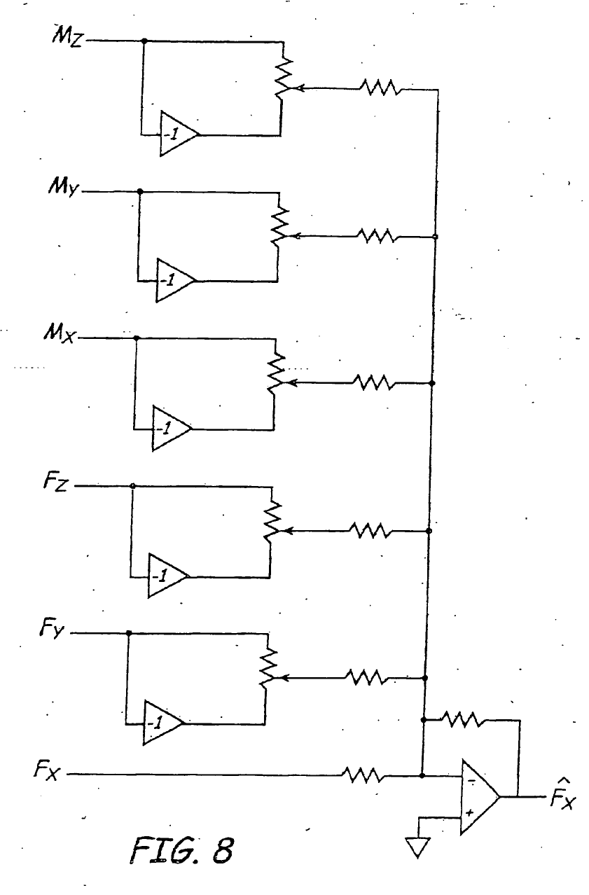

As stated above, cross-coupling compensation is provided by circuit 96. By way of example, FIG. 8 illustrates cross-coupling compensation for signal Fₓ. Each of the other output signals F_{y}, F_{z}, Mₓ, M_{y}, and M_{z} are similarly compensated for cross-coupling effects.

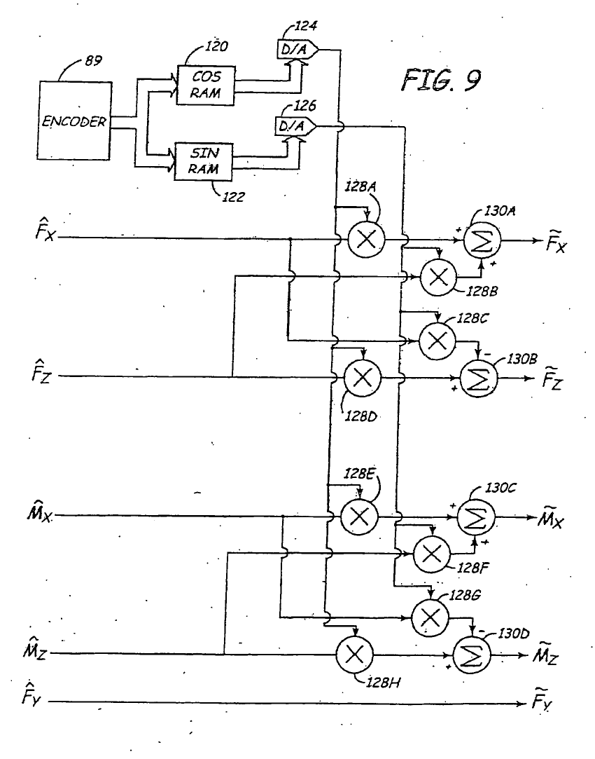

FIG. 9 illustrates in detail the coordinate transformation circuit 102. The encoder 89 provides an index for sine and cosine digital values stored in suitable memory 120 and 122 such as RAM (Random Access Memory). Digital to analog converters 124 and 126 received the appropriate digital values and generate corresponding analog signals indicative of the angular position of the load cell 10. Multipliers 128A to 128H and adders 130A to 130D combine force and moment output signals along and about the X-axis and the Z-axis so as to provide force and moment output signals 108 with respect to a static orthogonal coordinate system.

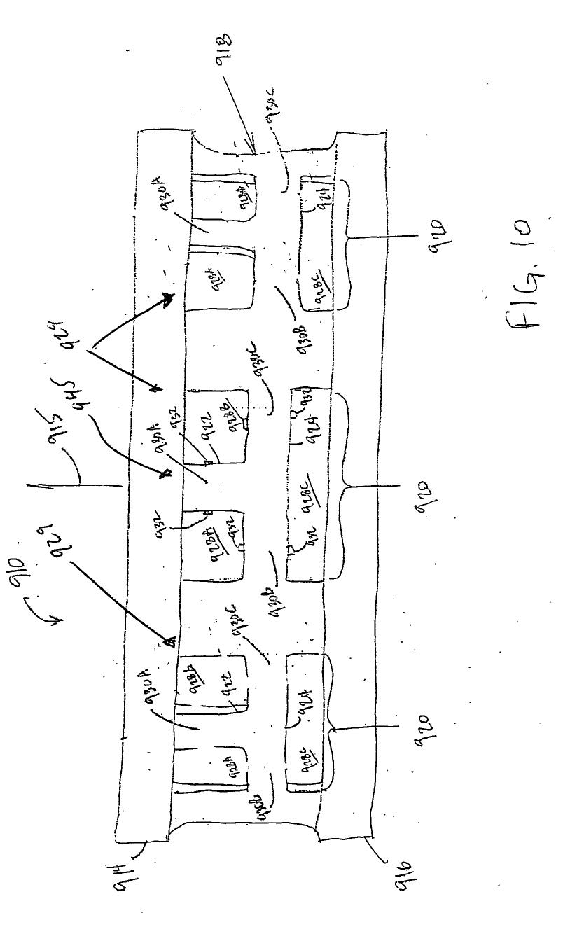

FIG. 10 shows a side elevational view of another embodiment of a load cell 910. The load cell 910 includes a body 912 having a first annular ring 914 and a second annular ring 916, each ring having a central aperture centered on a reference axis 915, similar to the load cell 10. Load cell 910 also includes a cylindrical member 918 disposed between the annular rings 914, 916. The cylindrical member 918 further includes a plurality of sensor assemblies 920 (at least three, but herein eight by way of example) spaced apart at generally equal angular intervals around the load cell 910. The sensor assemblies include flexure members 945 herein comprising first and second beam members 922, 924 attached to each other. Beam member 922 generally extends in the direction of the reference axis 915 and beam member 924 generally extends in a direction perpendicular to the reference axis 915. Beam member 922 is attached to the first annular ring 914, and beam member 924 is attached to masses 926 of the cylindrical member 918. The sensor assemblies 920 also include openings 929, and in particular, openings 928A, 928B, 928C, which define the flexure members 945. In this embodiment, three flexure members 930A, 930B, 930C are each compliant/sensitive in a single direction in a manner similar to the flexure pairs discussed above, and are oriented similarly. A plurality of sensors 932 (schematically represented in FIG. 10, where the placement thereof may not be exact) can be attached to the flexure members to resolve forces on and moments about the load cell 910 in manner similar to that described above, e.g. with Wheatstone bridges as in FIG. 3A on every other sensor assembly 920. Similarly, a load cell within the scope of the present disclosure can also include three or more flexure members in each set of flexure members of a sensor assembly.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A load cell body suitable for transmitting forces and moments in a plurality of directions, the load cell body comprising:
an integral assembly having:
a first ring member and a second ring member, each ring member having a central aperture centered on a reference axis; and
at least three sensor assemblies extending from the first ring member to the second ring member parallel to the reference axis, wherein each sensor assembly includes is spaced apart from the reference axis and includes a first flexure member extending parallel to the reference axis and joined to the first ring member, and two second flexure members joined to and oriented orthogonal to the first flexure member.

2. The load cell body of claim 1 wherein each of the first flexure members are joined to the first ring member at a first end and joined to the corresponding second flexure members at a second end.

3. The load cell body of claim 2 wherein for each sensor assembly one of the second flexure members is joined to the corresponding first flexure member on one side thereof extending in a first direction and the other corresponding second flexure member is joined to the corresponding first flexure member on an opposite side and extending in a second direction opposite the first direction.

4. The load cell body of claim 3 wherein the first flexure member of each sensor assembly comprises a plurality of first flexure members oriented in the same direction relative to each other.

5. The load cell body of claim 4 wherein the second flexure member of each sensor assembly comprises a plurality of second flexure members oriented in the same direction relative to each other.

6. The load cell body of claim 5 wherein the flexure members of the plurality of first flexure members are substantially identical, and wherein the flexure members of the plurality of the second flexure members are substantially identical.

7. The load cell body of claim 6 wherein each of the sensor assemblies includes three apertures to form each of the plurality of first flexure members.

8. The load cell body of claim 7 wherein each of the sensor assemblies includes to three apertures to form each of the plurality of second flexure members.

9. The load cell of claim 8 wherein each of the sensor assemblies includes seven apertures to form each of the plurality of first flexure members and each of the plurality of second flexure members.

10. The load cell of claim 9 and further comprising sensors operable with each of the plurality of first flexure members and each of the plurality of second flexure members.

11. The load cell of claim 10 wherein the sensors are disposed on an inner surface of an aperture between each of the plurality of first flexure members and are disposed on an inner surface of an aperture between each of the plurality of second flexure members.

12. The load cell of claim 2 and further comprising sensors operable with each of first flexure members and each of second flexure members.

13. The load cell of claim 9 wherein apertures forming each of the plurality of first flexure members each sensor assembly are joined to apertures forming each of the plurality of first flexure members of each adjacent sensor assembly with isolation openings.

14. The load cell of claim 13 wherein the isolation openings comprise slits.

15. The load cell of claim 13 wherein each sensor assembly includes one of the apertures forming one of the second plurality of flexure members extending in the first direction joined to one of the apertures forming one of the second plurality of flexure members extending in the second direction with an isolation opening.

16. The load cell of claim 15 wherein each of the isolation openings comprise a slit.

17. A method of making a load cell body for transmitting forces and moments in plural directions, the method comprising the steps of:
fabricating from a single block of material an integral assembly having a first annular ring, a second annular ring, wherein each annular ring has a central aperture centered on a reference axis; and
forming a plurality of bores within each member in a direction perpendicular to the reference axis, wherein the bores form sensor assemblies each of the senor assemblies comprising a first flexure member joined to the first ring member at a first end and joined to corresponding second flexure members at a second end, wherein one of the second flexure members is joined to the corresponding first flexure member on one side thereof extending in a first direction and the other corresponding second flexure member is joined to the corresponding first flexure member on an opposite side and extending in a second direction opposite the first direction.

18. The method of claim 17 wherein the step of forming the plurality of bores comprises forming the plurality of bores wherein each of the first flexure members comprise a pair of first flexure members, and wherein each of the second flexure members comprise a pair of second flexure members.

19. The method of claim 18 wherein the step of forming comprises forming bores where each of the plurality of first flexure members of each sensor assembly are joined to bores forming each of the plurality of first flexure members of each adjacent sensor assembly with isolation openings, and wherein each sensor assembly includes one of the bores forming one of the second plurality of flexure members extending in the first direction joined to one of the bores forming one of the second plurality of flexure members extending in the second direction with an isolation opening.

20. The method of claim 19 wherein each of the isolation openings comprise a slit.

21. A load cell body suitable for transmitting forces and moments in a plurality of directions, the load cell body comprising: an integral assembly having a first ring member and a second ring member, wherein each ring member has a central aperture centered on a reference axis and wherein three or more sensor assemblies extend from the first ring member to the second ring member parallel to the reference axis, wherein, the sensor assemblies include spaced-apart apertures forming three pairs of flexure members.
